(19) United States
(12) Patent Application Publication
(10) Pub. No.: US 2023/0020027 A1
(43) Pub. Date: Jan. 19, 2023

(54) DYNAMIC NETWORK RESOURCE SLICE PARTITION SIZE ADJUSTMENT

(71) Applicant: AT&T Intellectual Property I, L.P., Atlanta, GA (US)

(72) Inventors: Feza Buyukdura, Fairview, TX (US); David Lewis, Freehold, NJ (US)

(21) Appl. No.: 17/371,174

(22) Filed: Jul. 9, 2021

(51) Int. Cl. H04W 16/10; H04W 28/02; H04W 28/16; H04W 24/08; H04L 12/26

(52) U.S. Cl. CPC H04W 16/10; H04W 28/0289; H04W 28/16; H04W 24/08; H04L 43/0876

(57) ABSTRACT

Dynamic network resource slice partition size adjustment is provided herein. A method can include partitioning resources enabled via a communication network among network slices of the communication network, the network slices comprising an expandable network slice and a contractable network slice, obtaining a resource usage value for the expandable network slice, the resource usage value indicating a first proportion of the resources enabled via the communication network being used by the expandable network slice, and in response to the resource usage value being greater than a threshold, reallocating a portion of the resources enabled via the communication network from the contractable network slice to the expandable network slice, the portion of the resources being defined based on a function of a ratio of the first proportion to a second proportion of the resources enabled via the communication network being used by the contractable network slice.

### TECHNICAL FIELD

The present disclosure relates to communication networks, and, in particular, to techniques for adjusting resource slice partition sizes in a communication network.

### BACKGROUND

Radio access network (RAN) resource partitioning can be used for different groups of traffic in a communication network, e.g., to enable prioritization of network resources among different classes of users and/or services during instances of network congestion. This partitioning can be performed based on standards-based 5G (fifth generation) network slicing, or by other means, e.g., according to a public land mobile network (PLMN) identifier (ID), service profile identifier (SPID), or other means. Resource partitioning allows for control of the amount of RAN resources that respective groups of traffic can use. The RAN resources that are partitioned can be related to resources such as a physical resource block (PRB) to process user traffic and/or for control channel-related purposes.

### DESCRIPTION OF DRAWINGS

FIG. 1 is a block diagram of a system that facilitates dynamic network resource slice partition size adjustment in accordance with various aspects described herein.

FIG. 2 is a diagram that depicts example network resource partitions that can be dynamically adjusted using various aspects as described herein.

FIG. 3 is a block diagram that depicts example functionality of the resource controller device of FIG. 1 in accordance with various aspects described herein.

FIGS. 4-5 are block diagrams of respective systems that facilitate dynamic network resource slice partition size adjustment based on network congestion conditions in accordance with various aspects described herein.

FIGS. 6-8 are block diagrams of respective systems that facilitate dynamic network resource slice partition size adjustment based on changes to network resource usage conditions over time in accordance with various aspects described herein.

FIGS. 9-10 are flow diagrams of respective methods that facilitate dynamic network resource slice partition size adjustment in accordance with various aspects described herein.

FIG. 11 depicts an example computing environment in which various embodiments described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

In an aspect, a method as described herein can include partitioning, by a system including a processor, resources enabled via a communication network among network slices of the communication network, where the network slices include an expandable network slice and a contractable network slice. The method can further include obtaining, by the system, a resource usage value for the expandable network slice, where the resource usage value indicates a first proportion of the resources enabled via the communication network being used by the expandable network slice. The method can further include, in response to the resource usage value being greater than a threshold, reallocating, by the system, a portion of the resources enabled via the communication network from the contractable network slice to the expandable network slice. The portion of the resources can be defined based on a function of a ratio of the first proportion to a second proportion of the resources enabled via the communication network being used by the contractable network slice.

In another aspect, a system as described herein can include a processor and a memory that stores executable instructions that, when executed by the processor, facilitate performance of operations. The operations can include partitioning communication resources associated with a communication network among respective network slices, the network slices including an expandable network slice and a contractable network slice; determining a resource usage value indicative of a first proportion of the communication resources associated with the communication network being used by the expandable network slice; and, in response to the resource usage value being determined to be greater than a usage threshold, repartitioning a portion of the communication resources associated with the communication network from the contractable network slice to the expandable network slice according to a function of a ratio, where the ratio is the ratio of the first proportion of the communication resources to a second proportion of the communication resources associated with the communication network being used by the contractable network slice.

In a further aspect, a non-transitory machine-readable medium as described herein can include executable instructions that, when executed by a processor, facilitate performance of operations. The operations can include partitioning resources enabled via a communication network among network slices of the communication network, where the network slices include a first network slice and a second network slice; determining a resource usage value for the first network slice indicative of a first proportion of the resources enabled via the communication network used by the first network slice at a first time; and, in response to the resource usage value being greater than a threshold, reallocating a portion of the resources enabled via the communication network from the second network slice to the first network slice, where the portion of the resources is defined based on a function of a ratio of the first proportion to a second proportion of the resources enabled via the communication network used by the second network slice.

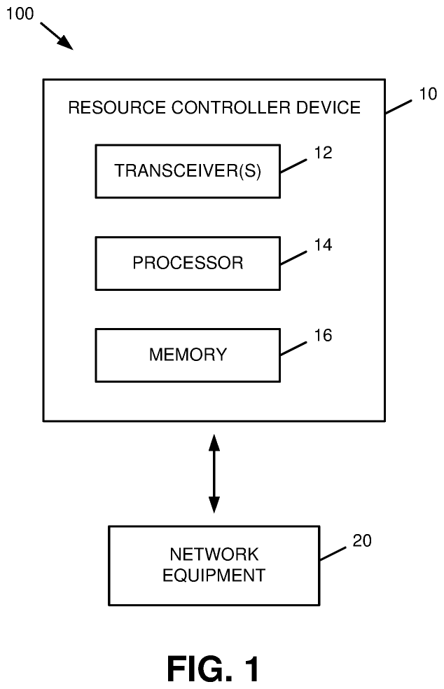

Referring first to FIG. 1, a system 100 that facilitates dynamic network resource slice partition size adjustment is illustrated. System 100 as shown by FIG. 1 includes a resource controller device 10 that can communicate with network equipment 20 associated with a communication network. In an aspect, the resource controller device 10 and the network equipment 20 can form at least a portion of a wireless communication network. While only one resource controller device 10 and one network equipment 20 are illustrated in FIG. 1 for simplicity of illustration, it is noted that a wireless communication network can include any amount of resource controller devices 10, network equipment 20, and/or other devices.

In an aspect, the resource controller device 10 shown in system 100 can be implemented by one or more elements of a radio access network (RAN), such as an eNodeB (eNB), gNodeB (gNB), or other network access point, a RAN controller device, and/or any other device(s) of the RAN that can implement controls on communication resources utilized by the network equipment 20. Alternatively, the resource controller device 10 can be implemented by one or more devices that communicate with elements of the RAN, such as an Element Management System (EMS), network elements utilizing the Open Network Automation Platform (ONAP) Service Management and Orchestration architecture, or the like. In still another example, the resource controller device 10 can reside on a different network from the network equipment 20, such as a core network that is connected to a RAN in which the network equipment 20 operates and/or any other suitable networks. While the resource controller device 10 is shown in FIG. 1 as a single device, it is noted that the functionality of the resource controller device 10 as described herein could be distributed among multiple distinct devices that can communicate with each other over the wireless communication network and/or by other means, such as a backhaul link that facilitates direct communication between respective RAN devices.

In an aspect, the network equipment 20 shown in system 100 can include any suitable device(s) that can communicate over a wireless communication network associated with the resource controller device 10. Such devices can include, but are not limited to, cellular phones, computing devices such as tablet or laptop computers, autonomous vehicles, Internet of Things (IoT) devices, etc. Also or alternatively, the network equipment 20 could include a device such as a modem, a mobile hotspot, or the like, that provides network connectivity to another device (e.g., a laptop or desktop computer, etc.), which itself can be fixed or mobile. In still another example, the network equipment 20 could include devices, such as base stations, eNBs, gNBs, or the like, that facilitate access by other network equipment 20 to the communication network. Thus, in some implementations, a network access point could include some or all functionality of both the resource controller device 10 and the network equipment 20.

The resource controller device 10 shown in system 100 can include one or more transceivers 12 that can communicate with (e.g., transmit messages to and/or receive messages from) the network equipment 20 and/or other devices in system 100. The transceiver 12 can include respective antennas and/or any other hardware or software components (e.g., an encoder/decoder, modulator/demodulator, etc.) that can be utilized to process signals for transmission and/or reception by the resource controller device 10 and/or associated network devices. While the resource controller device 10 and network equipment 20 are illustrated in system 100 as engaging in direct communications, it is noted that the resource controller device 10 could also be configured to conduct direct communications with a limited subset of the network equipment 20, such as network access points or the like, without directly communicating with other network equipment 20.

In an aspect, the resource controller device 10 can further include a processor 14 and a memory 16, which can be utilized to facilitate various functions of the resource controller device 10. For instance, the memory 16 can include a non-transitory computer readable medium that contains computer executable instructions, and the processor 14 can execute instructions stored by the memory 16. For simplicity of explanation, various actions that can be performed via the processor 14 and the memory 16 of the resource controller device 10 are shown and described below with respect to various logical components. In an aspect, the components described herein can be implemented in hardware, software, and/or a combination of hardware and software. For instance, a logical component as described herein can be implemented via instructions stored on the memory 16 and executed by the processor 14. Other implementations of various logical components could also be used, as will be described in further detail where applicable.

In an aspect, the processor 14 and the memory 16 of the resource controller device 10 can facilitate dynamic size adjustment of slice partitions and/or other RAN resource partitions using configurable parameters in order to improve the flexibility and effectiveness of network resources, e.g., in the event that the network experiences a threshold amount of congestion. The resource controller device 10 can initially preconfigure slice sizes across a macro network, either according to a uniform configuration or a non-uniform configuration that provides regional variation of the initial slice sizes. Based on various factors that will be described in further detail below, the resource controller device 10 can then apply real-time dynamic adjustments to the resource partition sizes, e.g., on a per-cell basis.

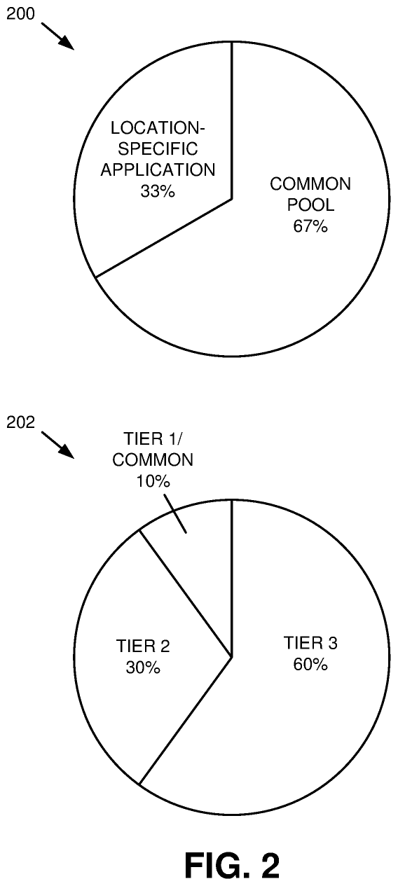

Turning now to FIG. 2, and with further reference to FIG. 1, examples of network resource partitions that can be adjusted by the resource controller device 10 are illustrated by diagrams 200 and 202. Network slices, e.g., as shown by diagrams 200 and 202, can be used to partition network resources on the basis of criteria such as users, applications, and/or any other factors for which network resources are desirably divided. In an aspect, a device, such as a device of the network equipment 20, operating in a communication network can establish one or more sessions between the device and a core network associated with the communication network to facilitate communication with other devices or network components operating in the communication network. Based on the user and/or application that is associated with a given session, the session can be assigned a slice ID or other identifier that associates the session to one or more network slices. From the slice ID associated with the session, the network equipment 20 can then be assigned resources from corresponding network slices. Each device of the network equipment 20 operating in this manner can have multiple open sessions, each of which can in turn utilize resources from the same network slice or different network slices. For example, a first application running on a device could utilize resources from a first network slice, while a second application running on the same device could utilize resources from a second, different network slice.

In an aspect, network slices or other partitions can be used to protect a given set of users or applications from other sets of users or applications and/or to limit the impact of a set of users or applications on other applications or users. For example, diagram 200 illustrates a set of two network slices that can be utilized in a localized environment (e.g., a stadium, a place of business, etc.) that is associated with a location-specific application (e.g., a guided tour application at a museum, a premium stadium application, etc.). As shown, a first slice partition associated with the location-specific application is assigned one-third of the available resources, or approximately 33%, while the remaining two-thirds of the available resources, or approximately 67%, are assigned to a common resource pool.

A partitioning of network resources, such as that shown by diagram 200, can apply in the presence of network congestion to enforce a guaranteed quality of service associated with one or more of the partitions, such as a quality of service guaranteed by a service level agreement (SLA), or to limit the impact on users or applications associated with a given partition from those associated with other partitions. Thus, with reference to diagram 200, if less than a threshold amount of congestion is present in the local network, users or applications associated with of the common pool of resources can in some cases use more than the designated two-thirds of total network resources. However, if sufficient congestion is present in the network, the location-specific application can be given full and exclusive access to the resources partitioned to it, e.g., such that other applications are not permitted to use those resources.

As another example, diagram 202 illustrates a set of three network slice partitions that can be applied across one or more cells of a macro network. The three partitions shown in diagram 202 correspond to different service or user tiers, which can be associated with respectively associated SLAs or other quality of service parameters. In particular, the three partitions shown in diagram 202 are assigned to three service tiers in which the first tier is allocated 10% of available resources, the second tier is allocated 30% of available resources, and the third tier is allocated 60% of available resources. As additionally shown in diagram 202, the partition associated with the first tier is further associated with a common pool of resources, e.g., in a similar manner to diagram 200. In an aspect, partitions such as those shown in diagram 202 can be allocated on a per-cell basis according to available RAN resources at the cell, typical usage patterns for the cell, etc. Also or alternatively, the partitions for the respective tiers can be adjusted per cell according to the typical userbase for that cell, and/or other factors.

Compared to the example of a localized environment shown in diagram 200, the resource partitions shown in diagram 202 can be subject to increased variation of network use over time. For instance, the relative amount of active users corresponding to the respective service tiers could vary according to the time of day, seasonal usage patterns, or the like. By way of example, in a network in which fixed wireless users share network resources with mobility users, the fixed wireless users can utilize a comparatively higher proportion of the network resource at night while the mobility users can utilize comparatively more network resources during the day. Also or alternatively, the relative amount of users corresponding to each service tier could vary pseudo-randomly, e.g., due to users of the respective service tiers entering or leaving the cell area.

As a result of variation in network activity as described above, the quality of service experienced at a given service tier can differ from the intended quality of service for that tier. By way of example, in a system in which there is one user associated with tier 2 and one hundred users associated with tier 3, the partitions shown in diagram 202 would result in the user associated with tier 2 being allocated a significantly higher proportion of the resources than the users associated with tier 3, even if the SLA for tier 3 guarantees a higher quality of service than that associated with other tiers.

In view of the above, the resource controller device 10 of system 100 can utilize preconfigured initial slice sizes across a macro network, e.g., the partitions shown in diagram 202, and perform real-time dynamic adjustments to the RAN resource partition sizes per cell as desired based on changing network conditions. This ability to dynamically adjust the RAN Slice sizes can improve the performance of a communication network by, e.g., providing the capability to protect one group of users from another set of users. For example, the resource controller device 10 can operate as described herein to protect standard mobility user traffic from fixed wireless user traffic, or to protect standard post-paid mobility user traffic from prepaid user traffic, and/or to provide similar protections. As traffic associated with different user groups can vary significantly in different cells and/or at different times, dynamic adjustment of partition sizes can improve the resiliency of resource partitions as compared to fixed partitioning.

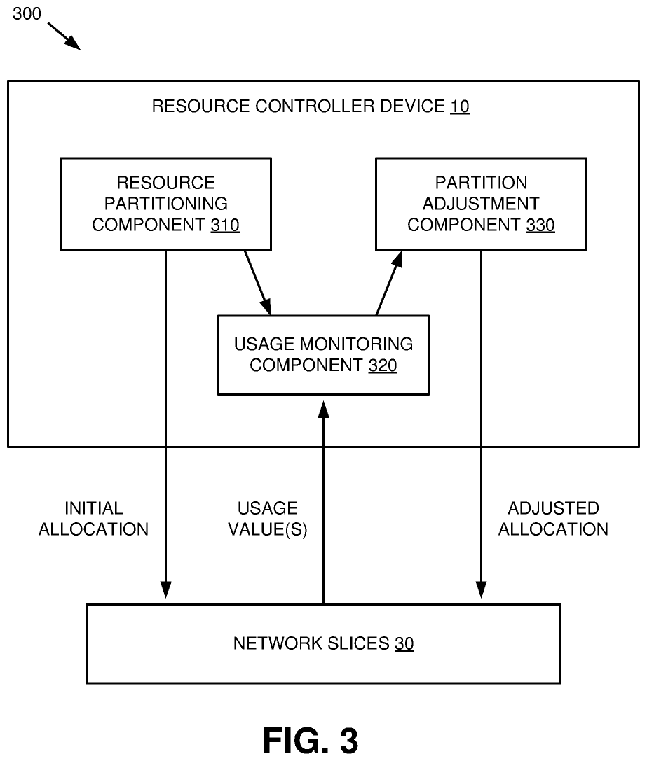

With reference now to FIG. 3, a block diagram of a system 300 that facilitates dynamic network resource slice partition size adjustment is illustrated. Repetitive description of like elements employed in other embodiments described herein is omitted for brevity. System 300 as shown in FIG. 3 includes a resource controller device 10 that can operate in a similar manner to that described above with respect to FIG. 1. As shown in FIG. 3, the resource controller device 10 of system 300 can include a resource partitioning component 310 that can partition resources enabled via a communication network, e.g., a communication network associated with the resource controller device 10, among network slices 30 of the communication network.

While the network slices 30 are illustrated as a block in FIG. 3 for purposes of illustration, it is noted that the network slices 30 are not associated with a physical element of system 300 but are instead representative of network resource partitions that can be utilized by a communication network associated with system 300. In an aspect, communications originating from the resource controller device 10 as shown in system 300 can be instructions or other commands that are provided to one or more network devices associated with the network slices 30, such as a base station or access point (not shown) that is responsible for setting the sizes of the respective network slices 30, which can in turn adjust the network slice partition sizes as described herein. Similarly, communications shown in system 300 as originating from the network slices 30 can be provided to the resource controller device 10 by devices associated with the network slices 30, which can be the same as, or different from, the devices to which the resource controller device 10 issues commands or instructions. In in implementation in which the functionality of the resource controller device 10 is provided by a base station, access point, or other RAN device that directly manages partitioning of the network slices 30, the communication flows shown in system 300 could be internal communication flows within the resource controller device 10 itself, e.g., communications between respective hardware or software components of the resource controller device 10. Other implementations are also possible.

In an aspect, the resource partitioning component 310 of the resource controller device 10 can facilitate an initial allocation of network resources among respective network slices 30. The initial allocation can facilitate initialization of the network slices 30 according to default partition sizes, which can be based on estimated usage information for a given cell associated with the resource controller device 10, network-wide or localized average usage statistics, and/or other factors.

In another aspect, the resource partitioning component 310 can designate respective ones of the network slices 30 as contractible network slices and/or expandable network slices, e.g., based on properties of the respective network slices. As used herein, a “contractible” network slice refers to a network slice or partition that is vulnerable to dynamic slice size adjustments, e.g., by a partition adjustment component 330 as will be described below. Conversely, if a given slice, e.g., as denoted by its slice ID, is not configured to be vulnerable to dynamic slice adjustment, the resource controller device 10 can be configured to not dynamically reduce the partition size for that slice. In an aspect, the resource controller device 10 can determine whether or not a slice ID is configured to be vulnerable to dynamic reduction based on uses associated with that slice ID. For instance, a slice ID that is associated with FirstNet communication and/or other public safety or security uses, has a minimum required partition size according to an SLA or other agreement, and/or satisfies other similar conditions, can be configured to not be contractible by the resource controller device 10.

As further used herein, an “expandable” network slice refers to a network slice or partition that is capable of being dynamically increased by the resource controller device 10. Conversely, if a given slice ID is not configured to be capable of dynamic slice increases, then the resource controller device 10 can be configured to not dynamically increase the size of that slice, even if the usage of that slice increases relative to that of other slices.

To summarize the above, with reference to the initial or default allocation, the size of a contractible network slice can be dynamically reduced by the resource controller device 10 to below its initial or default allocated size, while the size of an expandable network slice can be dynamically increased by the resource controller device 10 beyond its initial or default allocated size. Further, a network slice of the network slices 30 can be both expandable and contractible, or neither expandible nor contractible, where appropriate.

With reference again to the resource controller device 10, the resource controller device 10 further includes a usage monitoring component 320 that can obtain resource usage values corresponding to respective ones of the network slices 30, e.g., from an access point or other device that facilitates communication via the network slices 30 as described above. In an aspect, a resource usage value corresponding to a network slice can indicate a proportion of the resources enabled by an underlying communication network, e.g., the total resources allocated to the network slices 30, that are being used by that network slice. It is noted that the usage values obtained by the usage monitoring component 320 differ from the slice allocations described above in that the usage values indicate an amount of resources currently in use by a given slice ID, which can in some cases be greater than, or less than, the amount of resources allocated to that slice ID.

In an aspect, a usage value corresponding to a network slice as provided to the usage monitoring component 320 can indicate usage of any suitable type of resources allocated to the network slices 30, and can include any indicators that can relate to the usage of RAN resources. These indicators can include, but are not limited to, the following:

1) The number of devices in a given cell using the corresponding network slice.

2) The number of bearers and/or quality of service (QoS) flows using the corresponding network slice. In an aspect, bearers and/or QoS flows can be associated with a communication session associated with a device (e.g., a device of the network equipment 20 as shown in FIG. 1). A device can have multiple active sessions, each of which can be individually assigned to the same or different slice IDs. Accordingly, each bearer or QoS flow associated with a given session can utilize resources of the slice ID assigned to its corresponding session.

3) An amount of user traffic being processed using the corresponding network slice, e.g., within a defined measurement window prior to determining the usage value. This can, for example, indicate the relative throughput of devices or device sessions assigned to a given slice ID.

4) An amount of control channel resources or other RAN-related resources utilized by the corresponding network slice, and/or any other suitable usage-based metrics.

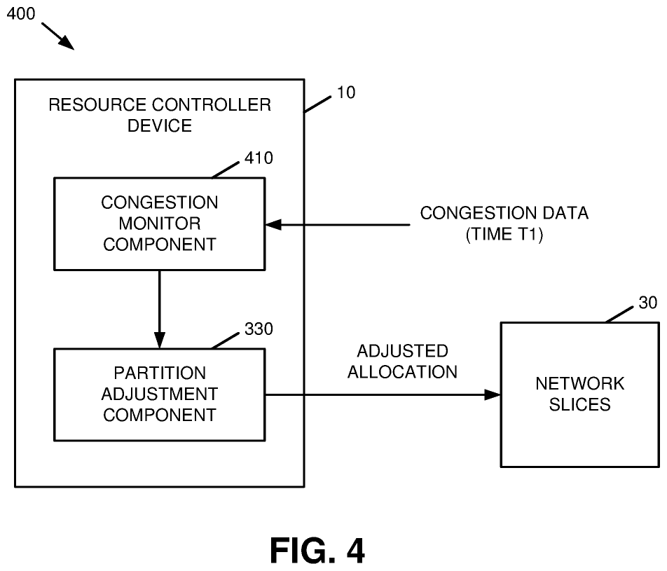

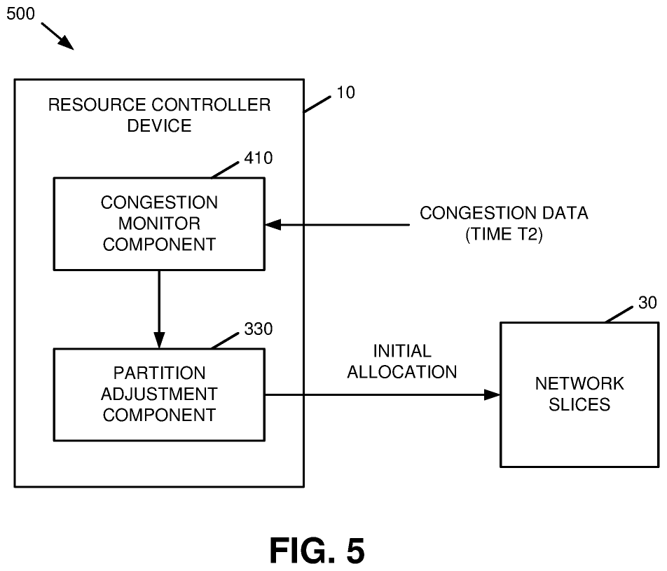

The resource controller device 10 shown in system 300 further includes a partition adjustment component 330, which, in response to a resource usage value received by the usage monitoring component 320 being greater than a threshold, can reallocate a portion of the resources enabled by the underlying communication network, resulting in an adjusted allocation of the network slices 30. In an aspect, the threshold utilized by the partition adjustment component 330 can be based on usage relative to allocation for a given network slice. For instance, size adjustments can be performed by the partition adjustment component 330 in response to the resource usage associated with a target slice being equal or near equal to the allocation for that slice or a portion (e.g., as given by a percentage or other measure) of the total allocation for the slice. Alternatively, the threshold utilized by the partition adjustment component 330 can be a measure of network congestion, e.g., as given by a percentage or other portion of the total resources of the communication network being used by respective ones of the network slices 30. Techniques for performing partition adjustment based on network congestion are described in further detail below with respect to FIGS. 4-5.

In an aspect, the extent of adjustments performed by the partition adjustment component 330 can be based on relative resource usage between different ones of the network slices 30 and/or other suitable measures. For example, in response to the usage of an expandable network slice being sufficiently high to trigger a dynamic size increase, the amount to which the expandable network slice is increased can be defined as a function of a ratio of the usage of the expandable network slice (e.g., as a first proportion of the total amount of enabled network resources used by the expandable network slice) to the usage of one or more contractible network slices (e.g., as a second proportion of the total amount of enabled network resources used by the contractible network slice(s)).

Turning now to FIG. 4, a block diagram of a system 400 that facilitates dynamic network resource slice partition size adjustment based on network congestion conditions is illustrated. Repetitive description of like elements employed in other embodiments described herein is omitted for brevity. As noted above, enforcement of resource partitions associated with respective network slices 30 can be dependent on network congestion, e.g., such that the partitions are not enforced or enforced comparatively lightly during periods of low congestion and enforced comparatively strictly during periods of higher congestion. Similarly, whether and/or to what extent adjustment of the partition sizes associated with the network slices 30 is performed, e.g., by the partition adjustment component 330, can be based on an amount of congestion present in the communication network, e.g., as determined by a congestion monitor component 410 of the resource controller device as shown in system 400.

In an aspect, the congestion monitor component 410 of the resource controller device 10 can determine an amount of congestion present in a communication network associated with the network slices 30 based on one or more measures of congestion such as physical resource block (PRB) utilization, control channel utilization, or the like. It is noted, however, that the congestion monitor component 410 could utilize any suitable metric or combination of metrics, either presently known or developed in the future, for measuring congestion associated with one or more network slices 30 of the communication network.

In the event that the congestion monitor component 410 detects no network congestion, or network congestion that is less than a threshold for triggering action by the partition adjustment component 330, the partition adjustment component 330 can be configured to refrain from performing dynamic slice partition adjustments. Conversely, in response to the amount of congestion determined by the congestion monitor component 410 being determined to be greater than a congestion threshold, e.g., a threshold set by the resource controller device 10 for triggering partition adjustments, the partition adjustment component 330 can be configured to reallocate resources between respective ones of the network slices 30, e.g., from a contractible network slice to an expandable network slice, as described above with respect to FIG. 3.

In the example shown by system 400, the amount of congestion measured by the congestion monitor component 410 at a time T1, e.g., based on congestion-related data received by the congestion monitor component 410, is greater than a defined threshold. Accordingly, as further shown by system 400, the partition adjustment component 330 facilitates an adjusted allocation of the network slices 30 at time T1. If, at a subsequent time T2 as shown by system 500 in FIG. 5, the amount of congestion present in the communication system as measured by the congestion monitor component 410 is determined to have decreased below the defined threshold as described above, the partition adjustment component 330 can then revert the reallocation shown in system 400 of FIG. 4, e.g., by returning any portion(s) of the communication resources associated with the network slices 30 to their original partition(s), at time T2, resulting in the network slices 30 being returned to their initial allocation.

In an aspect, the congestion monitor component 410 and the partition adjustment component 330 as shown in FIGS. 4-5 can utilize multiple defined congestion thresholds corresponding to different reallocation schemes. For instance, the partition adjustment component 330 can be configured to perform a first reallocation at a first congestion threshold (e.g., more than 80% of available resources utilized by the network slices 30) and to perform a second, more aggressive reallocation at a second congestion threshold that is higher than the first congestion threshold (e.g., more than 90% of available resources utilized by the network slices 30). Other implementations could also be used.

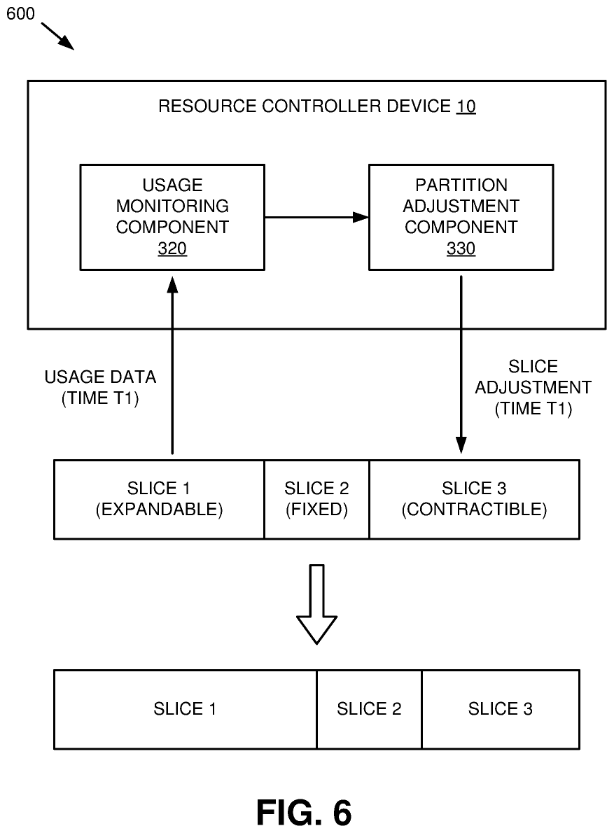

With reference now to FIGS. 6-8, an example of dynamic network resource slice partition size adjustment based on changes to network resource usage conditions over time is illustrated. Referring first to FIG. 6, system 600 depicts an initial state of a set of network slices, e.g., immediately prior to and during an initial time T1. The depicted set of network slices includes a first slice (slice 1) that is expandable but not contractible, a second slice (slice 2) that is fixed in size, e.g., neither expandable nor contractible, and a third slice (slice 3) that is contractible but not expandable. At time T1, slices 1 and 3 are equal in size, and slice 2 utilizes a remainder of the network resources not utilized by slices 1 or 3. Additionally, while not shown in FIGS. 6-8 for simplicity, it is noted that the partition size adjustments shown in FIGS. 6-8 can either be independent of network congestion, or that a sufficient amount of congestion is present in the network (e.g., as determined by a congestion monitor component as described above with respect to FIGS. 4-5) to trigger the adjustments shown in FIGS. 6-8.

As further shown by FIG. 6, the usage monitoring component 320 of the resource controller device 10 can obtain usage data, e.g., a resource usage value, from the network slices at time T1. In an aspect, this usage data can correspond to a single network slice, e.g., such that the usage data is representative of the total usage of network resources associated with a given slice, e.g., via bearers and/or sessions assigned to that slice. Alternatively, the usage data could correspond to a combination of slices, such as all non-fixed slices (here, slices 1 and 3), or all slices.

Based on the usage data provided to the usage monitoring component 320 at time T1, the partition adjustment component 330 can facilitate a reallocation of resources, e.g., from contractible slice 3 to expandable slice 1, under defined conditions. In an aspect, if the usage of an expandable slice (e.g., slice 1) exceeds a configured value, e.g., as determined based on a proportion of the usage of the expandable slice relative to the total allocated resources for the expandable network slice or all network slices, the usage of the expandable slice can be compared to the usage of other slices (e.g., slices 2 and/or 3), resulting in a ratio of usage. Based on this ratio of usage, the partition size of the expandable slice can then be dynamically increased by the partition adjustment component 330, e.g., based on a function of the ratio of usage and/or the total resource utilization of the respective network slices.

In an aspect, the function utilized by the partition adjustment component 330 for partition reallocation can be configured such that the amount of resources that are reallocated to an expandable network slice from a contractible network slice is proportional to a ratio of the usage of the expandable slice to the usage of the contractible network slice. It is noted, however, that any suitable function could be utilized for reallocation of resources between respective network slices. Additionally, the function utilized by the partition adjustment component 330 could be further based on the amount of congestion present in the system, e.g., as described above with respect to FIGS. 4-5. In another aspect, the formula utilized by the partition adjustment component 330 could itself be adjusted over time, e.g., by an operator of the underlying communication network and/or the resource controller device 10, as desired according to varying network conditions or usage patterns and/or other criteria.

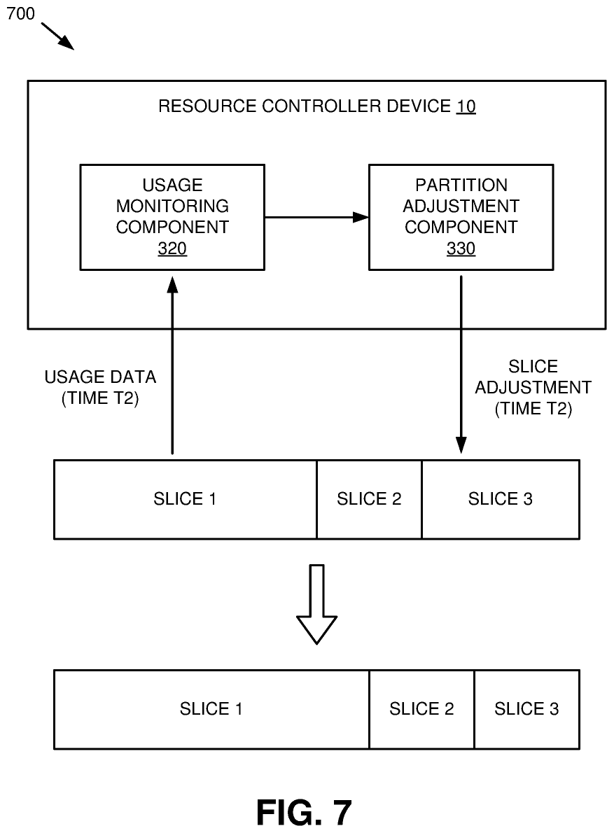

As a result of the usage data received at time T1, the partition adjustment component 330 can facilitate reallocation of resources from contractible slice 3 to expandable slice 1, e.g., as shown by FIG. 6. At a time T2 subsequent to time T1 as shown in FIG. 6, the usage monitoring component 320 can obtain second usage data, e.g., a second resource usage value, that can indicate similar usage information to the first usage data described above. As shown by system 700 in FIG. 7, in the event that the usage data received at time T2 indicates that the usage of an expandable network slice (e.g., slice 1) has continued to increase relative to the usage of other slices, the partition adjustment can further increase the partition size of the expandable network slice relative to the other slices, e.g., by repeating the reallocation of resources from one or more contractible network slices (e.g., slice 3) to the expandable network slice, and/or by repartitioning further resources from one or more contractible network slices to the expandable network slice in any other suitable manner

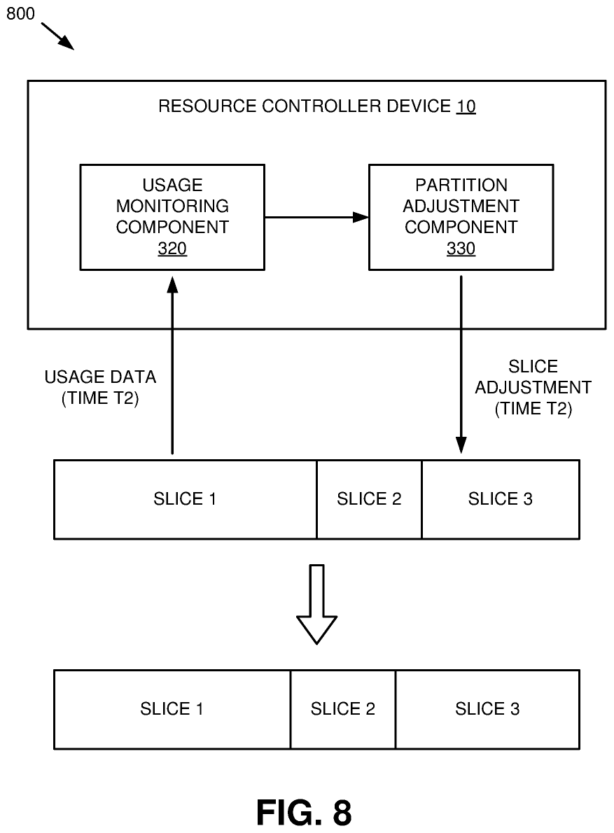

Alternatively, as shown by system 800 in FIG. 8, in the event that the usage data received at time T2 indicates that the usage of the expandable network slice (e.g., slice 1) has decreased relative to the usage of other slices, the partition adjustment component 330 can adjust the size of the expandable network slice downward, e.g., by returning or reallocating at least a portion of the resources repartitioned to the expandable slice at time T1 back to the contractible network slice(s) to which those resources were originally assigned. It is noted that the labels “expandable” and “contractible” as applied to respective network slices are relative only to their initial allocations, and that resources can be allocated or returned to any network slice(s) in any manner provided that they do not go below (for an expandable network slice) or exceed (for a contractible network slice) those initial allocations. While the reallocation at time T2 as shown by FIG. 8 is a partial reallocation, it is further noted that the partition adjustment component 330 could instead perform a full reallocation, e.g., by returning all slices back to their original allocations, if desired based on the usage of the network at time T2. In another aspect, a reallocation as shown by FIG. 8 could also be performed in response to abatement of congestion in the underlying communication network, e.g., as monitored as described above with respect to FIGS. 4-5.

As an additional numerical example of a reallocation that can be performed by the resource controller device 10, initial (preset) configurations for a group of four network slices, given slice IDs A-D, respectively, can be given by the Table 1 below:

TABLE 1
Initial configurations for example slice IDs A-D.

| Slice ID | Expandable? | Contractible? | Initial size (%) |
|---|---|---|---|
| A | Yes | Yes | 20% |
| B | No | No | 10% |
| C | No | Yes | 20% |
| D | Yes | Yes | 50% |

In the event that no cell congestion is present (e.g., as determined by a congestion monitor component 410 as described above with respect to FIGS. 4-5), dynamic adjustment can be omitted, e.g., by the partition adjustment component 330 of the resource controller device 10. Conversely, in the event that cell congestion is present, the usage ratio of the slices can be determined, e.g., by the usage monitoring component 320 of the resource controller device, as shown by Table 2 below. It is noted that the usage ratios shown in Table 2 are relative to the total amount of resources used in the cell, which could differ from the total amount of resources allocated to the cell.

TABLE 2
Initial usage ratios for example slice IDs A-D.

| Slice ID | Usage ratio |
|---|---|
| A | 35% |
| B | 5% |
| C | 25% |
| D | 35% |

Based on the usage ratios for the respective slices, the partition sizes of the slices can be changed, e.g., by the partition adjustment component 330 of the resource controller device 10, according to a formula, e.g., as described above. This adjustment can result in the sizes of the respective partitions being altered, as shown by Table 3 below.

TABLE 3
Initial and adjusted sizes for example slice IDs A-D.

| Slice ID | Initial size | Adjusted size |
|---|---|---|
| A | 20% | 25% |
| B | 10% | 10% |
| C | 20% | 18% |
| D | 50% | 47% |

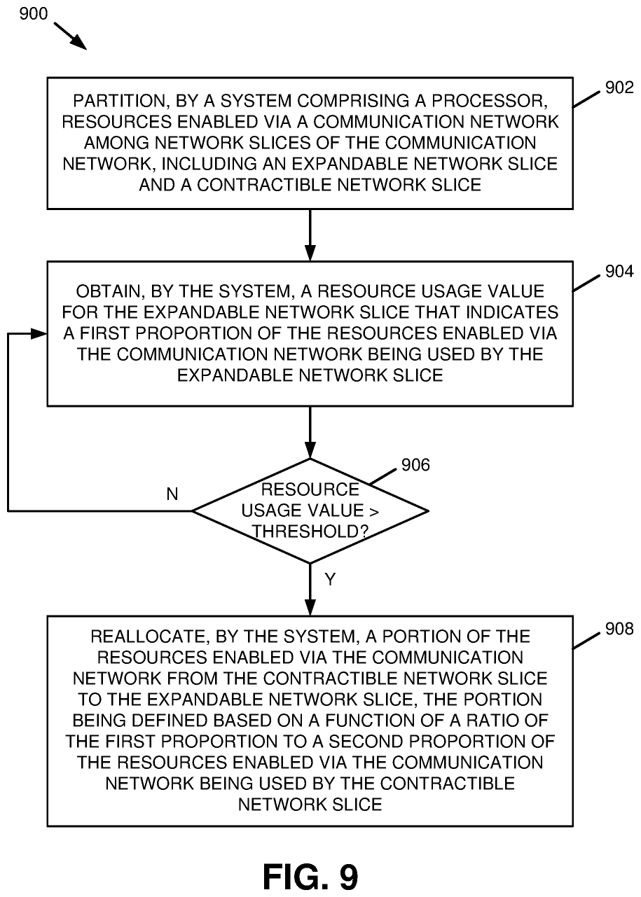

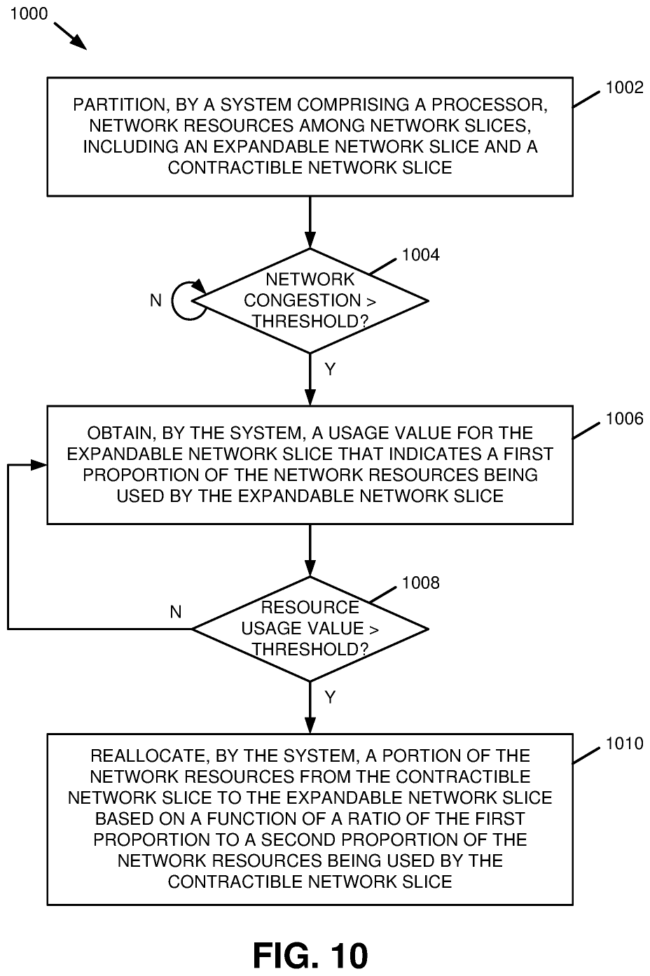

FIGS. 9-10 illustrate methods in accordance with certain aspects of this disclosure. While, for purposes of simplicity of explanation, the methods are shown and described as a series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

With reference to FIG. 9, a flow diagram of a method 900 that facilitates dynamic network resource slice partition size adjustment is presented. At 902, a system comprising a processor (e.g., a resource controller device 10 comprising a processor 14, and/or a system including such a device) can partition (e.g., by a resource partitioning component 310 and/or other components implemented by the processor 14) resources enabled via a communication network among network slices (e.g., network slices 30) of the communication network. In an aspect, these network slices can include an expandable network slice (e.g., a network slice that is capable of dynamic size increases) and a contractible network slice (e.g., a network slice that is vulnerable to dynamic size decreases).

At 904, the system can obtain (e.g., by a usage monitoring component 320 and/or other components implemented by the processor 14) a resource usage value for the expandable network slice that indicates a first proportion of the resources enabled via the communication network that are in use by the expandable network slice.

At 906, the system can determine (e.g., by the usage monitoring component 320 and/or other components implemented by the processor 14) whether the resource usage value obtained at 904 exceeds a defined threshold. If the resource usage value does not exceed the threshold, method 900 can return to 904 to obtain an updated resource usage value.

If, instead, the resource usage value is determined at 906 to exceed the threshold, method 900 can conclude at 908, in which the system can reallocate (e.g., by a partition adjustment component 330 and/or other components implemented by the processor 14) a portion of the resources enabled via the communication network from the contractible network slice to the expandable network slice. In an aspect, the portion of the resources that are reallocated at 908 can be defined based on a function of a ratio of the first proportion of the resources used by the expandable network slice as determined at 904 to a second proportion of the resources enabled via the communication network being used by the contractible network slice.

Turning to FIG. 10, a flow diagram of another method 1000 that facilitates dynamic network resource slice partition size adjustment is presented. At 1002, a system comprising a processor (e.g., a resource controller device 10 comprising a processor 14, and/or a system including such a device) can partition (e.g., by a resource partitioning component 310 and/or other components implemented by the processor 14) network resources among network slices that include an expandable network slice and a contractible network slice, e.g., in a similar manner to 902 as described above.

At 1004, the system can determine (e.g., by a congestion monitor component 410 and/or other components implemented by the processor 14) whether an amount of congestion present in a network in which method 1000 operates exceeds a congestion threshold. If the congestion does not exceed the threshold, method 1000 can continue monitoring the network congestion as shown at 1004 until the congestion exceeds the threshold.

In response to determining at 1004 that at least a threshold amount of network congestion is present, method 1000 proceeds to 1006, in which the system can obtain (e.g., by a usage monitoring component 320 and/or other components implemented by the processor 14) a usage value for the expandable network slice, e.g., in a similar manner to 904 as described above.

At 1008, the system can determine (e.g., by the usage monitoring component 320 and/or other components implemented by the processor 14) whether the resource usage value obtained at 1006 exceeds a usage threshold. If the usage value does not exceed the usage threshold, method 1000 can return to 1006 to obtain an updated resource usage value. If the usage value does exceed the usage threshold, method 1000 can instead conclude at 1010, in which the system can reallocate (e.g., by a partition adjustment component 330 and/or other components implemented by the processor 14) a portion of the network resources from the contractible network slice to the expandable network slice, e.g., in a similar manner to 908 as described above.

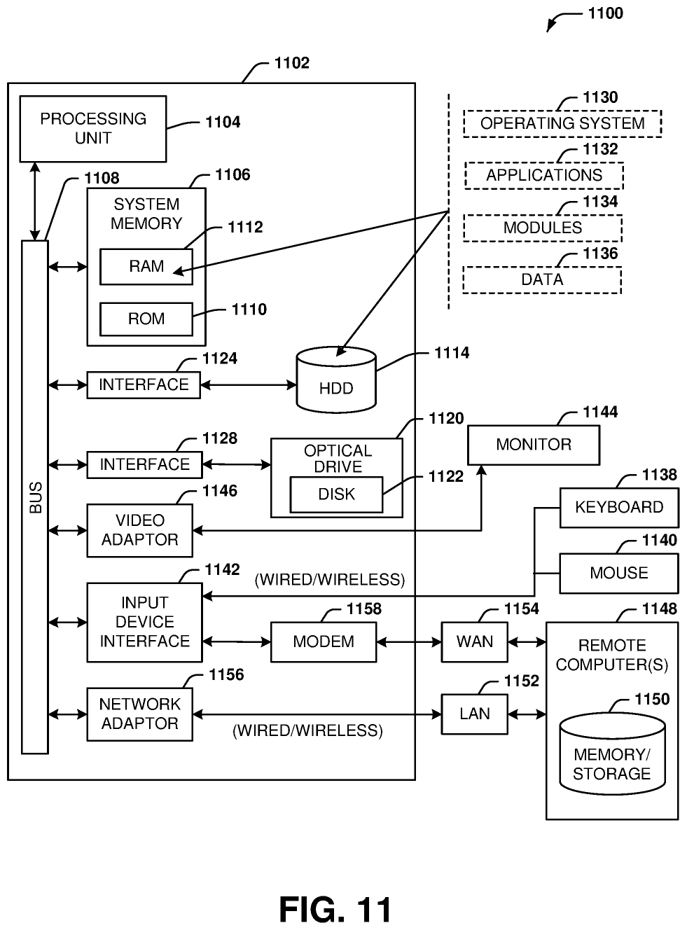

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 and an optical disk drive 1120, (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114 and optical disk drive 1120 can be connected to the system bus 1108 by an HDD interface 1124 and an optical drive interface 1128, respectively. The HDD interface 1124 can additionally support external drive implementations via Universal Serial Bus (USB), Institute of Electrical and Electronics Engineers (IEEE) 1394, and/or other interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) can include a microphone, an infrared (IR) remote control, a joystick, a game pad, a stylus pen, touch screen or the like. These and other input devices are often connected to the processing unit 1104 through an input device interface 1142 that can be coupled to the system bus 1108, but can be connected by other interfaces, such as a parallel port, an IEEE 1394 serial port, a game port, a USB port, an IR interface, a BLUETOOTH® interface, etc.

A monitor 1144 or other type of display device can be also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1152 through a wired and/or wireless communication network interface or adapter 1156. The adapter 1156 can facilitate wired or wireless communication to the LAN 1152, which can also include a wireless access point (AP) disposed thereon for communicating with the wireless adapter 1156.

When used in a WAN networking environment, the computer 1102 can include a modem 1158 or can be connected to a communications server on the WAN 1154 or has other means for establishing communications over the WAN 1154, such as by way of the Internet. The modem 1158, which can be internal or external and a wired or wireless device, can be connected to the system bus 1108 via the input device interface 1142. In a networked environment, program modules depicted relative to the computer 1102 or portions thereof, can be stored in the remote memory/storage device 1150. It will be appreciated that the network connections shown are example and other means of establishing a communications link between the computers can be used.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
partitioning, by a system comprising a processor, resources enabled via a communication network among network slices of the communication network, the network slices comprising an expandable network slice and a contractable network slice;
obtaining, by the system, a resource usage value for the expandable network slice, the resource usage value indicating a first proportion of the resources enabled via the communication network being used by the expandable network slice; and
in response to the resource usage value being greater than a threshold, reallocating, by the system, a portion of the resources enabled via the communication network from the contractable network slice to the expandable network slice, the portion of the resources being defined based on a function of a ratio of the first proportion to a second proportion of the resources enabled via the communication network being used by the contractable network slice.

2. The method of claim 1, further comprising:
determining, by the system, an amount of congestion present in the communication network, wherein the reallocating comprises reallocating the portion of the resources further in response to the amount of congestion present in the communication network being determined to be greater than a congestion threshold.

3. The method of claim 2, further comprising:
reverting, by the system, the reallocating in response to the amount of congestion present in the communication network being determined to have decreased below the congestion threshold.

4. The method of claim 1, wherein obtaining the resource usage value comprises obtaining the resource usage value based on a number of network devices using the expandable network slice in a cell of the communication network.

5. The method of claim 1, wherein obtaining the resource usage value comprises obtaining the resource usage value based on a number of bearers using the expandable network slice.

6. The method of claim 1, wherein obtaining the resource usage value comprises obtaining the resource usage value based on an amount of user traffic being processed via the expandable network slice.

7. The method of claim 1, wherein the resource usage value is a first resource usage value associated with a first time, and wherein the method further comprises:
obtaining, by the system, a second resource usage value for the expandable network slice, the second resource usage value indicating the first proportion of the resources enabled via the communication network being used by the expandable network slice at a second time that is after the first time.

8. The method of claim 7, further comprising:
in response to the second resource usage value being less than the first resource usage value, returning, by the system, a subset of the portion of the resources enabled via the communication network from the expandable network slice to the contractable network slice.

9. The method of claim 7, further comprising:
in response to the second resource usage value being greater than the first resource usage value, repeating, by the system, the reallocating.

10. A system, comprising:
a processor; and
a memory that stores executable instructions that, when executed by the processor, facilitate performance of operations, comprising:
partitioning communication resources associated with a communication network among a plurality of network slices, the plurality of network slices comprising an expandable network slice and a contractable network slice;
determining a resource usage value indicative of a first proportion of the communication resources associated with the communication network being used by the expandable network slice; and
in response to the resource usage value being determined to be greater than a usage threshold, repartitioning a portion of the communication resources associated with the communication network from the contractable network slice to the expandable network slice according to a function of a ratio, wherein the ratio is the ratio of the first proportion of the communication resources to a second proportion of the communication resources associated with the communication network being used by the contractable network slice.

11. The system of claim 10, wherein the operations further comprise:
determining a level of congestion present in the communication network, wherein the repartitioning comprises repartitioning the portion of the communication resources further in response to the level of congestion present in the communication network being determined to be greater than a congestion threshold.

12. The system of claim 11, wherein the operations further comprise:
returning the portion of the communication resources to the contractable network slice in response to the level of congestion present in the communication network being determined to have decreased below the congestion threshold.

13. The system of claim 10, wherein the resource usage value is a first resource usage value associated with a first time, and wherein the operations further comprise:
determining a second resource usage value indicative of the first proportion of the communication resources associated with the communication network being used by the expandable network slice at a second time that is after the first time.

14. The system of claim 13, wherein the operations further comprise:
in response to the second resource usage value being less than the first resource usage value, repartitioning a subset of the portion of the communication resources associated with the communication network from the expandable network slice to the contractable network slice.

15. The system of claim 13, wherein the operations further comprise:
in response to the second resource usage value being greater than the first resource usage value, repeating the repartitioning.

16. A non-transitory machine-readable medium, comprising executable instructions that, when executed by a processor, facilitate performance of operations, comprising:
partitioning resources enabled via a communication network among network slices of the communication network, the network slices comprising a first network slice and a second network slice;
determining a resource usage value for the first network slice indicative of a first proportion of the resources enabled via the communication network used by the first network slice at a first time; and
in response to the resource usage value being greater than a threshold, reallocating a portion of the resources enabled via the communication network from the second network slice to the first network slice, the portion of the resources being defined based on a function of a ratio of the first proportion to a second proportion of the resources enabled via the communication network used by the second network slice.

17. The non-transitory machine-readable medium of claim 16, wherein the operations further comprise:
reallocating the portion of the resources further in response to an amount of congestion present in the communication network being determined to be greater than a congestion threshold.

18. The non-transitory machine-readable medium of claim 17, wherein the operations further comprise:
reverting the reallocating in response to the amount of congestion present in the communication network being determined to be less than the congestion threshold after having been determined to be greater than the congestion threshold.

19. The non-transitory machine-readable medium of claim 16, wherein the resource usage value is a first resource usage value, and wherein the operations further comprise:
determining a second resource usage value for the first network slice indicative of the first proportion of the resources enabled via the communication network used by the first network slice at a second time that is after the first time; and
in response to the second resource usage value being less than the first resource usage value, returning a subset of the portion of the resources enabled via the communication network from the first network slice to the second network slice.

20. The non-transitory machine-readable medium of claim 16, wherein the resource usage value is a first resource usage value, and wherein the operations further comprise:
determining a second resource usage value for the first network slice indicative of the first proportion of the resources enabled via the communication network used by the first network slice at a second time that is after the first time; and
in response to the second resource usage value being greater than the first resource usage value, repeating the reallocating.
